(19) United States
(12) Patent Application Publication
(10) Pub. No.: US 2012/0160267 A1
(43) Pub. Date: Jun. 28, 2012

(54) CLEANING METHOD AND CLEANING APPARATUS

(76) Inventors: Masako KODERA, Yokohama-shi (JP); Xinming Wang, Tokyo (JP); Shinji Kajita, Tokyo (JP)

(21) Appl. No.: 13/227,280

(22) Filed: Sep. 7, 2011

(30) Foreign Application Priority Data
Dec. 27, 2010 (JP) P2010-290528

(51) Int. Cl. B08B 7/00; B08B 1/00

(52) U.S. Cl. 134/6; 15/21.1

(57) ABSTRACT

A cleaning method according to embodiments of the present invention is a cleaning method of cleaning residues from a semiconductor substrate by rotating a roll brush, the method having cleaning residues from the semiconductor substrate while pressing the roll brush against the semiconductor substrate with a first pressure of 7.35 kPa or lower, and cleaning residues from the semiconductor substrate while pressing the roll brush against the semiconductor substrate with a second pressure higher than 7.35 kPa.

### CROSS-REFERENCE TO RELATED APPLICATION

This application is based upon and claims the benefit of priority from the prior Japanese Patent Application No. 2010-290528, filed on Dec. 27, 2010; the entire contents of which are incorporated herein by reference.

### FIELD

Embodiments described herein relate generally to a cleaning method and a cleaning apparatus of a semiconductor substrate after being polished.

### BACKGROUND

Accompanying miniaturization of semiconductor devices, various techniques (for example, new materials and processing methods) are introduced in manufacturing of semiconductor devices. Among others, CMP (chemical mechanical polishing) has become an inevitable technique for manufacturing semiconductor devices for smoothing an interlayer dielectric film (ILD), forming an embedded shallow trench isolation (STI), a plug, and an embedded metal wire, and so on.

CMP is a technique to polish and smooth the surface of a semiconductor device, and a polishing agent called slurry is used in this polishing. In CMP, components contained in the polishing agent cause chemical reaction (for example, oxidization, hydration, complexation) on the surface of a semiconductor substrate, and by this chemical reaction, a layer formed on the surface of the semiconductor substrate is removed mechanically by polishing particles contained in the polishing agent.

After the polishing is finished, the entire semiconductor substrate including the polished surface is cleaned, and residues such as polishing particles adhering to the semiconductor substrate are removed. When these residues are present on the surface of a semiconductor substrate, they cause various adverse effects such as short-circuit of wires of semiconductor devices formed on this semiconductor substrate. Accordingly, various methods for cleaning residues from the surface of the semiconductor substrate have been proposed conventionally.

For example, there have been proposed a method of cleaning a semiconductor substrate by two rotating roll brushes sandwiching the semiconductor substrate, a method of cleaning a semiconductor substrate with a small brush (pen brush), a method of cleaning a semiconductor substrate using ultrasonic waves in the vicinity of 1 MHz (mega-sonic cleaning) , a method of cleaning a semiconductor substrate using shock waves generated when pure water and high-pressure gas (N₂) mixed in a nozzle are jetted to the semiconductor substrate, and liquid drops of the pure water collide with the surface of the semiconductor substrate (two-fluid jetting cleaning), and so on.

Further, although it is not cleaning after CMP, there is also provided a method such that in the method of cleaning a semiconductor substrate by two rotating roll brushes sandwiching the semiconductor substrate, cleaning is performed while pressing the roll brushes against the semiconductor substrate with a first pressure, and thereafter cleaning is performed while pressing the roll brushes against the semiconductor substrate with a second pressure lower than the first pressure.

However, in conventional cleaning methods, there has been a problem such that residues adhering to a semiconductor substrate after CMP cannot be removed sufficiently. Embodiments of the present invention are made for solving such a conventional problem, and an object thereof is to provide a cleaning method and a cleaning apparatus capable of efficiently removing residues from a semiconductor substrate after being polished.

A cleaning method according to embodiments of the present invention is a cleaning method of cleaning residues from a semiconductor substrate by rotating a roll brush, the method having cleaning residues from the semiconductor substrate while pressing the roll brush against the semiconductor substrate with a first pressure of 7.35 kPa or lower, and cleaning residues from the semiconductor substrate while pressing the roll brush against the semiconductor substrate with a second pressure higher than 7.35 kPa.

### BRIEF DESCRIPTION OF THE DRAWINGS

FIG. 1 is a side view of a polishing apparatus according to an embodiment.

FIG. 2 is a front view of roll brushes.

FIG. 3 is an explanatory view of a cleaning mechanism.

FIG. 4 is a flowchart illustrating operation of the polishing apparatus according to the embodiment.

FIG. 5 illustrates test results of Example 1.

FIG. 6 illustrates test results of Example 2.

### DETAILED DESCRIPTION

Hereinafter, embodiments of the present invention will be described in detail with reference to the drawings.

### Embodiment

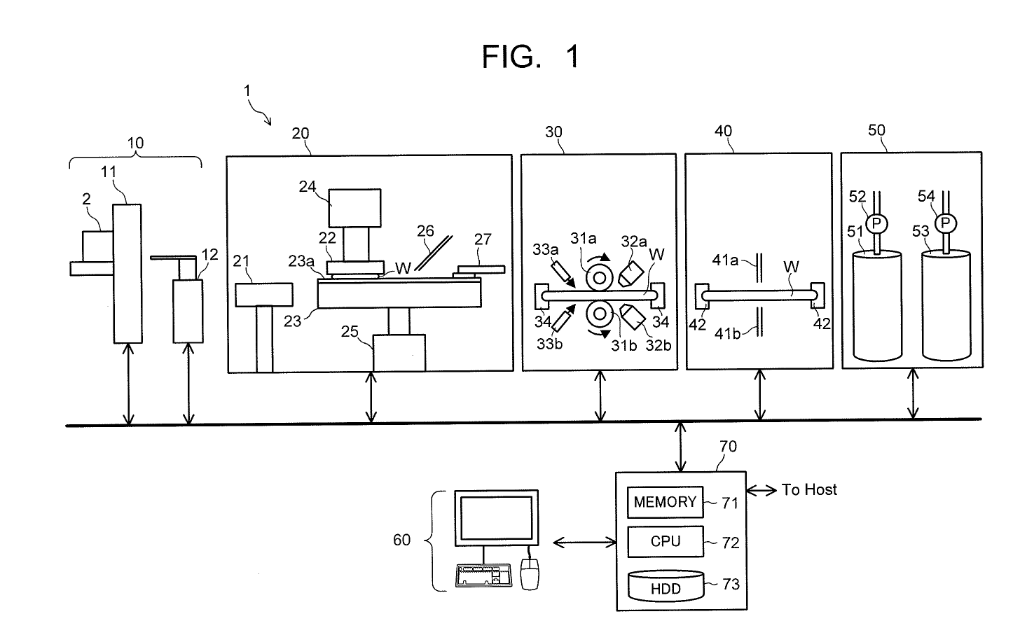

FIG. 1 is a side view of a polishing apparatus 1 according to an embodiment. As illustrated in FIG. 1, the polishing apparatus 1 according to the embodiment includes a carrying unit 10, a polishing unit 20, a cleaning unit 30, a drying unit 40, a chemical supply unit 50, an operating unit 60, and a control unit 70.

Hereinafter, respective units included in the polishing apparatus 1 will be described with reference to FIG. 1.

### <Carrying Unit 10>

The carrying unit 10 includes an opener 11 and a carrying robot 12. The opener 11 opens and closes a door of a container 2 in which a semiconductor substrate (hereinafter referred to as a wafer W) is housed. The carrying robot 12 carries the wafer W between the polishing unit 20, the cleaning unit 30, and the drying unit 40. The container 2 houses the wafer W as an object to be polished. The container 2 is, for example, a FOUP (Front Opening Unified Pod) or an SMIF (Standard of Mechanical Interface) Pod.

### <Polishing Unit 20>

The polishing unit 20 includes a transfer table 21, a top ring 22 (also referred to as a head), a turn table 23 (also referred to as a polishing table), a motor 24, a motor 25, a polishing agent supply nozzle 26, and a dresser 27.

The transfer table 21 is a table for transferring the wafer W between the carrying robot 12 and the top ring 22. The top ring 22 and the turn table 23 polish the wafer W. The motor 24 rotates the top ring 22. The motor 25 rotates the turn table 23. The polishing agent supply nozzle 26 supplies a polishing agent onto a pad 23a on the turn table 23. The dresser 27 dresses the pad 23a.

When the wafer W is carried into the polishing unit 20, the wafer W which is mounted with a surface (semiconductor devices are formed) to be polished facing down on the transfer table 21 by the carrying robot 12 is received by the top ring 22. When the wafer W is carried out of the polishing unit 20, the wafer W which is mounted on the transfer table 21 by the top ring 22 is received by the carrying robot 12, thereby transferring the wafer W.

The top ring 22 receives the wafer W which is mounted with the surface to be polished facing down on the transfer table 21 by the carrying robot 12. Thereafter, the top ring 22 transfers the wafer W to the turn table 23 which will be described later, and is driven to rotate by the motor 24 in a state that the surface to be polished of the wafer W is pressed against the pad 23a on the turn table 23.

From the polishing agent supply nozzle 26, a polishing agent (slurry) from the chemical supply unit 50 is supplied onto the pad 23a. The dresser 27 reciprocates over the pad 23a to condition the pad 23a.

### <Cleaning Unit 30>

The cleaning unit 30 includes roll brushes 31a, 31b, cleaning liquid supply nozzles 32a, 32b, pure water supply nozzles 33a, 33b, and a gripping unit 34. The roll brushes 31a, 31b clean the wafer W. From the cleaning liquid supply nozzles 32a, 32b, a cleaning liquid (for example, alkaline liquid such as ammonium solution) is supplied. From the pure water supply nozzles 33a, 33b, pure water for rinsing is supplied. The gripping unit 34 grips edge portions of the wafer W, and revolves to rotate the wafer W. When the wafer W is cleaned, the cleaning liquid is supplied from the cleaning liquid supply nozzles 32a, 32b, and the gripping unit 34 revolves to rotate the wafer W.

The roll brushes 31a, 31b are driven to rotate by a supporting member which will be described later. The roll brushes 31a, 31b sandwich the wafer W and clean the wafer W to remove residues such as polishing particles and the like adhering to the wafer W. After the wafer W is cleaned, pure water is supplied via the pure water supply nozzles 33a, 33b to rinse the wafer W. FIG. 1 illustrates the cleaning unit 30 employing a method to hold the wafer W in a horizontal direction (what is called a horizontal method), but the unit may employ a method to hold the wafer W in a vertical direction (what is called a vertical method). (Structures of the roll brushes 31a, 31b)

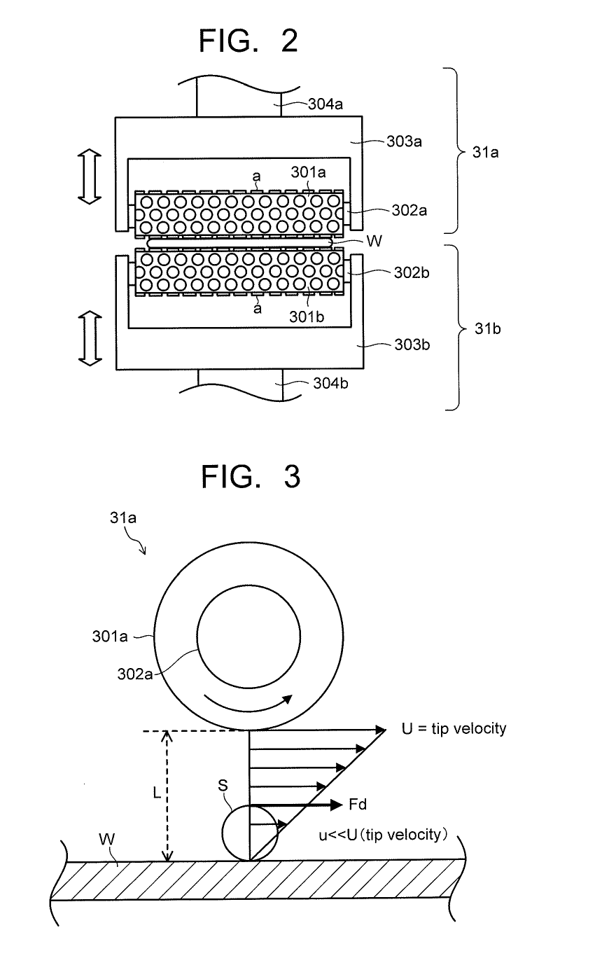

FIG. 2 is a front structural view of the roll brushes 31a, 31b. The structures of the roll brushes 31a, 31b will be described below with reference to FIG. 2. The roll brushes 31a, 31b have the same structure. In the description below, only the structure of the roll brush 31a will be described. The description of the structure of the roll brush 31b is omitted.

The roll brush 31a includes a brush body 301a, a core 302a, a supporting member 303a, and an air cylinder 304a. The brush body 301a is a spongy porous body formed in a cylindrical shape. On an outer peripheral face of the brush body 301a, plural rows of cylindrical projections are disposed. The core 302a is inserted in the brush body 301a along a longitudinal direction of the brush body 301a. The supporting member 303a supports the core 302a and rotates the core 302a. The air cylinder 304a is engaged with the supporting member 303a and drives the supporting member 303a in an upward and downward direction (arrow direction) of FIG. 2. Force to press the roll brush 31a against the surface of the wafer W is controlled by the pressure of nitrogen (N₂) gas or CDA (Clean Dry Air) supplied to the air cylinder 304a.

When the core 302a is rotated by the supporting member 303a, the brush body 301a rotates together with the core 302a. Next, the brush body 301a is pressed against the surface (cleaned surface) of the wafer W by the air cylinder 304a, thereby cleaning residues from the surface of the wafer W. In addition, the brush body 301a maybe rotated after the brush body 301a is pressed against the wafer surface . When the wafer W is cleaned, the cleaning liquid is supplied from the cleaning liquid supply nozzles 32a, 32b illustrated in FIG. 1. Note that in order to prevent the brush body 301a from only partially contacting the surface of the wafer W, the roll brush 31a is attached so that the outer periphery of the brush body 301a and the surface of the wafer W are substantially in parallel along the longitudinal direction of the roll brush 31a. Various shapes may be used as the shape of the brush body 301a. For example, a brush body with no projections formed on its outer peripheral face may be used.

### <Drying Unit 40>

The drying unit 40 includes jetting nozzles 41a, 41b and a gripping unit 42. The jetting nozzles 41a, 41b jet nitrogen gas or CDA onto the wafer W. The gripping unit 42 grips edge portions of the wafer W and revolves to rotate the wafer W. The drying unit 40 dries the wafer W by jetting nitrogen gas or CDA via the jetting nozzles 41a, 41b in a state that the wafer W is rotated by the gripping unit 42. Further, the wafer W may be dried by rotating at high speed without jetting of nitrogen gas or CDA.

<Chemical supply unit 50>

The chemical supply unit 50 includes a tank 51, a pump 52, a tank 53, and a pump 54. The tank 51 contains the polishing agent to be supplied to the polishing unit 20. The pump 52 delivers the polishing agent contained in the tank 51. The tank 53 contains the cleaning liquid to be supplied to the cleaning unit 30. The pump 54 delivers the cleaning liquid contained in the tank 53.

### <Operating Unit 60>

The operating unit 60 includes an input unit (for example, a keyboard and a mouse) , which accepts an instruction from the user (operator) and inputs the accepted instruction to the control unit 70, and a display (for example, a liquid crystal display or CRT (Cathode Ray Tube) displaying necessary information for operating the polishing apparatus 1.

### <Control Unit 70>

The control unit 70 includes a memory 71, a CPU (central processing unit) 72, and an HDD (hard disk drive) 73. In the HDD 73, there are stored an operating program for the polishing apparatus 1, processing conditions (polishing conditions and cleaning conditions) for the wafer W which are called recipes, and so on.

Each recipe is formed of polishing items and cleaning items. In the polishing items, necessary parameters for polishing the wafer W can be set. The parameters includes, for example, pressure (Pa) of the top ring 22, rotation speed (rpm) of the top ring 22, rotation speed (rpm) of the turn table 23, supply amount (cc/min) of the polishing agent, and rotation speed (rpm) of the dresser 27.

In the cleaning items, conditions can be set such as cleaning time (sec) of the wafer W, rotation speed (rpm) of the roll brushes 31a, 31b, pressing force of the roll brushes 31a, 31b against the wafer W (newton) , supply amounts (cc/min) of the cleaning liquid and the pure water, and so on in the cleaning unit 30.

The control unit 70 polishes and cleans the wafer W according to a recipe specified by the user via the operating unit 60, or a recipe specified by a host (not-illustrated).

### <Cleaning Mechanism>

FIG. 3 is an explanatory view of a cleaning mechanism. Hereinafter, a mechanism of cleaning (removing) residues from the wafer W will be described with reference to FIG. 3. Note that the cleaning mechanism is the same for the roll brush 31a side and the roll brush 31b side. In the following description, only the cleaning mechanism on the roll brush 31a side will be described. The description of the cleaning mechanism on the roll brush 31b side is omitted. Symbol U depicted in FIG. 3 is the velocity (tip velocity) of the outermost peripheral face of the brush body 301a of the roll brush 31a.

It is conceivable that force Fd to remove (hereinafter referred to as removing force Fd) residues S adhering to the surface of the wafer W occurs depending on the flow velocity u of cleaning liquid created by rotation of the roll brush 31a and rotation of the wafer W, and the distance L between the outermost peripheral face of the brush body 301a of the roll brush 31a and the wafer W.

That is, by rotation of the roll brush 31a and rotation of the wafer W, there occurs a hydroplane phenomenon such that the cleaning liquid enters between the roll brush 31a and the wafer

W. Then, it is conceivable that the flow of cleaning liquid which occurred between the roll brush 31a and the wafer W causes force to push and wash off the residues S, that is, the removing force Fd to operate on the residues S on the surface of the wafer W.

Here, the removing force Fd can be represented by the following expression (1).

Fd=(π·Cd·ρd²·u²)/8 (1)

Note that meanings of the parameters in the expression (1) are as follows.
π: circular constant
Cd: constant
ρ: density of cleaning liquid
d: diameter of residues S
u: flow velocity of cleaning liquid

Note that the above-described expression (1) is calculated by approximating the value of the flow velocity u to the relative velocity of the outer peripheral face of the brush body 301a of the roll brush 31a with respect to the wafer W (since the value of the flow velocity u of cleaning liquid depends on the distance between the roll brush 31a and the wafer W), and approximating the shape of residues S to a sphere.

From the above-described expression (1), it can be seen that as the size (diameter d) of residues S becomes small, the removing force Fd for residues S by flow of cleaning liquid becomes small, and as the size of residues S becomes large, the removing force Fd for residues S by flow of cleaning liquid becomes large. Further, from the above-described expression (1), it can be seen that as the flow velocity u of cleaning liquid becomes low, the removing force Fd for residues S by flow of the cleaning liquid becomes small , and as the flow velocity u of cleaning liquid becomes high, the removing force Fd for residues S by flow of the cleaning liquid becomes large.

From the above, it can be seen that for removing small size residues, the flow velocity u of cleaning liquid may be increased. Here, considering that the flow velocity of cleaning liquid occurring between the brush body 301a and the wafer W is highest on the outermost peripheral face of the brush body 301a of the roll brush 31a and is lowest on the surface of the wafer w, there are following two methods to increase the flow velocity u of cleaning liquid.

1: Increase the rotation speed (rpm) of the roll brush 31a per unit time.
2: Decrease the distance L between the outermost peripheral face of the brush body 301a of the roll brush 31a and the surface of the wafer W (increase the force to press the roll brush 31a against the wafer W).

On the other hand, according to the expression (1), regarding small size residues S, the removing force Fd for the residues S by flow of cleaning liquid is large even when the flow velocity u of cleaning liquid is low, and thus the residues can be removed with small force to press the roll brush 31a against the wafer W. Conversely, for removing large size residues S, when the force to press the roll brush 31a against the surface of the wafer W is increased and the distance L between the outermost peripheral face of the brush body 301a of the roll brush 31a and the surface of the wafer W is decreased, residues S washed away once by the cleaning liquid get stuck in the middle due to the large diameter d of the residues S, and become difficult to be discharged to the outside of the wafer W. Accordingly, for removing large size residues S, increasing the force to press the roll brush 31a against the surface of the wafer W makes it unable to remove the residues S inversely.

From the above, it can be understood that residues adhering to the surface of the wafer W can be removed efficiently by cleaning the wafer W in two separate steps as follows.
Step 1: Performing cleaning while pressing the roll brush 31a against the surface of the wafer W with small force, to thereby remove large size residues S.
Step 2: Performing cleaning while pressing the roll brush 31a against the surface of the wafer W with larger force than in step 1, to thereby remove small size residues S.

In addition, before step 1, processing of cleaning the wafer W while pressing the roll brush 31a against the surface of the wafer W with large force may be performed, to thereby tear away residues S cutting into or adhering strongly to the film of the surface of the wafer W.

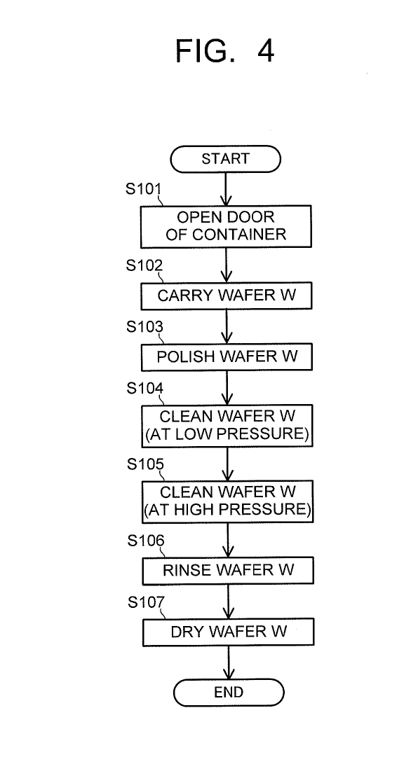

FIG. 4 is a flowchart illustrating operation of the polishing apparatus 1 according to the embodiment. Hereinafter, operation of the polishing apparatus 1 will be described with reference to FIG. 1 to FIG. 4 . In addition, the polishing apparatus 1 operates based on instructions from the control unit 70.

### <Step S101: Placing Process>

When the container 2 is set to the opener 11 by a carrying machine (for example, RGV (Rail Guided Vehicle) or OHV (Over Head Vehicle)) or operator, the door of the container 2 is opened by the opener 11.

### <Step S102: Carrying Process>

The carrying robot 12 of the carrying unit 10 carries out the wafer Was an object to be polished housed in the container 2 and reverses and mounts the wafer on the transfer table 21 of the polishing unit 20.

### <Step S103: Polishing Process>

The wafer W mounted on the transfer table 21 is received by the top ring 22, and then transferred to the turn table 23.

Thereafter, the pump 52 of the chemical supply unit 50 is driven to supply the polishing agent. Further, the turn table 23 is driven to rotate in a state that the surface (semiconductor devices are formed) to be polished of the wafer W is pressed against the pad 23a of the turn table 23, thereby polishing the surface of the wafer W.

### <Step S104: First Cleaning Process (at Low Pressure)>

After the polishing, the carrying robot 12 carries the wafer W from the polishing unit 20 to the cleaning unit 30. In the cleaning unit 30, the wafer W is cleaned and residues adhering to the wafer W are removed. Specifically, the wafer W carried to the cleaning unit 30 is gripped at edge portions of the wafer W by the gripping unit 34, and is rotated at the rotation speed (rpm) set in the recipe. Moreover, the cleaning liquid is supplied to the wafer W via the cleaning liquid supply nozzles 32a, 32b. Thereafter, the rotating roll brushes 31a, 31b are pressed against the wafer W with a pressure of 7.35 kPa or lower, so as to clean the wafer W. In this first cleaning process (at low pressure), among residues adhering to the surface of the wafer W, residues with a large particle diameter (150 nm or larger) are mainly removed.

### <Step S105: Second Cleaning Process (at High Pressure)>

After the first cleaning process is finished, the roll brushes 31a, 31b are pressed against the wafer W with a pressure higher than 7.35 kPa, and the wafer W is further cleaned. In the second cleaning process (at high pressure), residues with a small particle diameter (80 nm or larger and smaller than 150 nm) which are not removed in the first cleaning process (at low pressure) are mainly removed.

In this manner, by forming the cleaning process of the first and second cleaning processes, residues adhering to the wafer W can be removed efficiently.

### <Step S106: Rinsing Process>

After the cleaning, the pump 54 of the chemical supply unit 50 is stopped and the supply of the cleaning liquid is stopped, and the roll brushes 31a, 31b move away from the surface of the wafer W. Thereafter, pure water is supplied via the pure water supply nozzles 33a, 33b to rinse the wafer W. Incidentally, the wafer W is rotated by the gripping unit 34 during the rinsing.

### <Step S107: Drying Process>

After the rinsing is finished, the carrying robot 12 carries the wafer W from the cleaning unit 30 to the drying unit 40. In the drying unit 40, the wafer W is dried. Specifically, the wafer W carried to the drying unit 40 rotates in a state that the edge portions of the wafer W are gripped by the gripping unit 42, and nitrogen gas or CDA is jetted via the jetting nozzles 41a, 41b to dry the wafer W.

After the wafer W is dried, the carrying robot 12 houses the wafer W in the container 2, and the opener 11 closes the door of the container 2.

### EXAMPLES

Next, specific examples and test results of the polishing apparatus 1 according to the embodiment will be described. In the examples, using the polishing apparatus 1 according to the embodiment, there were examined the relation between the pressing force of a roll brush and residues on the wafer surface (Example 1), the relation between the velocity on the outermost peripheral face of the roll brush (hereinafter referred to as linear velocity) and residues on the wafer surface (Example 2), and changes of residues when the wafer is cleaned by the cleaning process divided into first and second steps (Example 3). Note that pressures described in each example are calculated from a contact area (954 mm²) between the brush body and the wafer during the cleaning.

### (Common Conditions)

First, processing conditions common to following Examples 1 to 3 will be described.

Object to be cleaned: a wafer with a diameter of 300 mm with an oxide film of 550 nm being formed on its surface is used.

Polishing agent: slurry for oxide film containing silica (SiO₂) as polishing particles is used.

Polishing time: 30 sec is set (the oxide film is polished by about 50 nm).

Cleaning liquid: pure water is used.

Brush body: one with an outer diameter φ of 60 mm formed in a cylindrical shape is used. On the outer peripheral face of the brush body, plural rows of cylindrical projections are disposed. The material of the brush body is PVA (polyvinyl alcohol). After the wafer is cleaned, the wafer is rinsed with pure water, and is dried with CDA.

### Example 1

In Example 1, the relation between the pressing force of a roll brush and residues on the wafer surface was checked. In Example 1, there were checked the size (diameter) of residues remaining on the wafer surface and the number thereof when the pressing force of the roll brush is varied from 2 N (pressure: 2.1 kPa) to 12 N (pressure: 12.6 kPa). In this check, a defect detection apparatus was used. The number of residues was checked for two cases. One case is that the size of residues is 80 nm or larger. Another case is that the size of residues 150 nm or larger. The pressure was calculated assuming that one row of plural cylindrical projections arranged on the surface of the brush body of the roll brush is in contact with the surface of the wafer W.

FIG. 5 is a chart illustrating test results of Example 1. The vertical axis and horizontal axis of FIG. 5 indicate the number of residues remaining on the wafer surface and the pressing force of the roll brush against the wafer surface, respectively. In FIG. 5, the number of residues of the size 80 nm or larger is denoted by a solid line, and the number of residues of the size 150 nm or larger is denoted by a dot and dash line.

From the results of FIG. 5, it can be seen that there are less residues of the size 150 nm or larger when the pressing force of the roll brush is lower, and conversely, there are less residues of the size 80 or larger when the pressing force of the roll brush is higher. The results of Example 1 match the description of the cleaning mechanism described with reference to FIG. 3.

Further, from the results of FIG. 5, it can be seen that when the pressing force of the roll brush against the wafer surface is 7 N (pressure: 7.35 kPa) or smaller, the number of residues of the size 150 nm or larger decreases accompanying decrease in pressing force, and conversely, when the pressing force of the roll brush against the wafer surface is higher than 7 N (pressure 7.35 kPa) , there is almost no change in the number of residues of the size 150 nm or larger even when the pressing force is varied. From the above, when the wafer is cleaned in two separate steps, it can be seen that the boundary of force of pressing the roll brush against the wafer surface is preferred to be 7 N (pressure: 7.35 kPa).

### Example 2

In Example 2, the relation between the linear velocity of the roll brush and residues on the wafer surface was checked.

In Example 2, the size (diameter) and the number of residues remaining on the wafer surface when the linear velocity is varied were checked for each of when the pressing force of the roll brush is 2 N (pressure: 2.1 kPa) and when the pressing force of the roll brush is 12 N (pressure: 12.6 kPa). In this check, a defect detection apparatus was used. The number of residues was checked for two sizes of residues, 80 nm or larger and 150 nm or larger. Incidentally, the pressure was calculated assuming that one row of plural cylindrical projections arranged on the surface of the brush body of the roll brush is in contact with the surface of the wafer W.

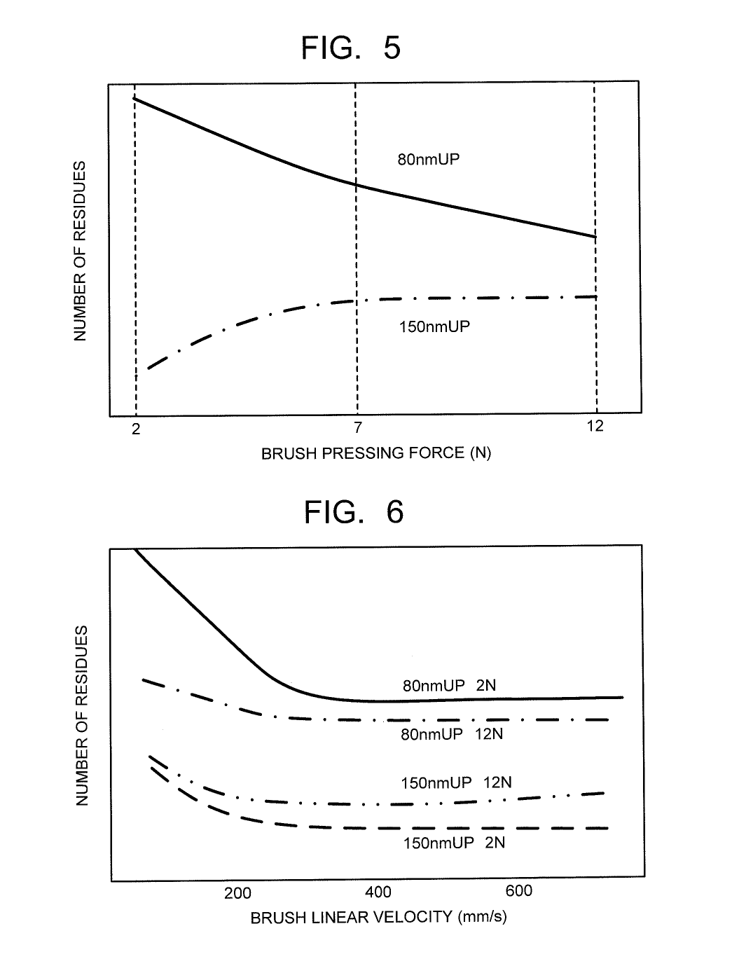

FIG. 6 is a chart illustrating test results of Example 2. The vertical axis and horizontal axis of FIG. 6 indicate the number of residues remaining on the wafer surface and the linear velocity of the roll brush, respectively. Further, in FIG. 6, the number of residues of the size 80 nm or larger when the force of the brush is 2 N (pressure: 2.1 kPa) is denoted by a solid line, and the number of residues of the size 80 nm or larger when the force of the brush is 12 N (pressure: 12.6 kPa) is denoted by a dot and dash line. Moreover, the number of residues of the size 150 nm or larger when the force of the brush is 2 N (pressure: 2.1 kPa) is denoted by a dashed line, and the number of residues of the size 150 nm or larger when the force of the brush is 12 N (pressure: 12.6 kPa) is denoted by a two-dot and dash line. Incidentally, the linear velocity of the roll brush was calculated from the diameter of the roll brush and the rotation speed (rpm) thereof.

From the results of FIG. 6, it can be seen that the number of residues is smaller when the linear velocity of the roll brush is higher for both the size 80 nm or larger and the size 150 nm or larger. Further, when the linear velocity of the roll brush becomes 200 mm/s or higher, it can be seen that even when the linear velocity of the roll brush is increased, the number of residues barely changes. Accordingly, a sufficient cleaning effect can be obtained when the linear velocity of the roll brush is 200 mm/s or higher.

Furthermore, from the results of FIG. 6, it can be seen that there are less residues of the size of 150 nm or larger consistently when the pressing force is low (2 N (pressure: 2.1 kPa)) than when the pressing force of the roll brush is high (12 N (pressure: 12.6 kPa)), and there are less residues of the size of 80 nm or larger consistently when the pressing force is high (12 N (pressure: 12.6 kPa)) than when the pressing force of the roll brush is low (2 N (pressure: 2.1 kPa)) . The results of this Example 2 match the description of the cleaning mechanism described with reference to FIG. 3 and the results of Example 1 illustrated in FIG. 5.

### Example 3

In Example 3, changes of residues when the wafer is cleaned by the cleaning process divided into the following two steps were checked.
Step 1: Cleaning the wafer with the pressing force of the roll brush against the wafer surface of 2 N (pressure: 2.1 kPa) and the linear velocity of the roll brush between 400 mm/s and 600 mm/s.
Step 2: Cleaning the wafer with the pressing force of the roll brush against the wafer surface of 12 N (pressure: 12.6 kPa) and the linear velocity of the roll brush between 400 mm/s and 600 mm/s.

The number of residues remaining on the wafer surface was checked after the wafer is cleaned under the above conditions. As compared to the case where the cleaning is performed by a conventional cleaning method in which the pressing force of the roll brush against the wafer surface while cleaning the wafer is constant between 7 N and 12 N, and the pressing force against the wafer is not changed in middle, the number of residues of the size 150 nm or larger decreased to ⅔, and the number of residues of the size 80 nm or larger decreased to ½.

Moreover, before the above step 1, the wafer was cleaned with the pressing force of the roll brush against the wafer surface of 12 N or higher and the linear velocity of the roll brush between 400 mm/s and 600 mm/s, and thereafter the cleaning under the conditions of step 1, 2 was performed. In this case, the number of residues of the size 150 nm or larger decreased to ⅓, and the number of residues of the size 80 nm or larger decreased to ⅓. This is conceivably because residues cutting into or adhering strongly to the film of the wafer surface are torn off by cleaning while pressing the roll brush 31a against the surface of the wafer W with large force.

In addition, the present inventors performed cleaning of residues from the wafer surface using an ammonium solution (pH 10 to pH 12) instead of pure water as the cleaning liquid. However, no difference from the case of using pure water was recognized.

As described above, it was found that residues adhering to the wafer surface can be removed efficiently by performing cleaning while pressing the roll brush against the wafer surface with force of 7 N or smaller, and thereafter performing cleaning while pressing the roll brush against the wafer surface with force larger than 7 N (pressure: 7.35 kPa) . It was also found that residues can be reduced further by performing cleaning while pressing the roll brush against the wafer with force of 12 N (pressure: 12.6 kPa) or larger before performing cleaning while pressing the roll brush against the wafer with force of 7N (pressure : 7.35 kPa) or smaller.

Note that in each example, residues of the size smaller than 80 nm were not checked, which is because the size of residues that can be measured by the defect measuring apparatus is 80 nm or larger. Residues of the size smaller than 80 nm cannot be distinguished from pseudo-defects such as scratches, and hence the number of residues cannot be counted accurately. From the cleaning mechanism described with reference to FIG. 3, it can be easily inferred that residues of the size smaller than 80 nm are also removed effectively by performing cleaning in two separate steps. Further, the pressures are not strictly limited to 2 N (2.1 kPa) 7 N (pressure: 7.35 kPa) , and 12 N (pressure: 12.6 kPa), and the tendency to decrease the number of residues after cleaning compared to conventional techniques does not change when the pressures are in the range of ±2 N (pressure: 2.1 kPa) from the respective pressures being the center value.

### Other Embodiments

While certain embodiments have been described, these embodiments have been presented by way of example only, and are not intended to limit the scope of the inventions. Indeed, the novel embodiment described herein may be embodied in a variety of other forms; furthermore, substitutions and changes in the form of the embodiments described herein may be made without departing from the spirit of the inventions. The accompanying claims and their equivalents are intended to cover such forms or modifications as would fall within the scope and spirit of the inventions.

For example, after only the front surface side on which semiconductor devices are formed is cleaned while pressing the roll brush against the front surface of the wafer with force of 7 N (pressure : 7.35 kPa) or smaller, the front surface may be cleaned while pressing the roll brush against the front surface of the wafer with force larger than 7 N, and for the rear surface side on which the semiconductor devices are formed, the force to press the roll brush against the wafer rear surface may be kept constant between 7 (pressure: 7.35 kPa) and 12 N (pressure: 12.6 kPa) and not changed in the middle of cleaning.

Moreover, after the wafer is cleaned by the roll brush, the wafer may be cleaned by a small brush (pen brush) , mega-sonic cleaning, two-fluid jet cleaning, or the like. Further, a nozzle to supply pure water to the drying unit 40 may be provided, and the wafer W may be rinsed in the drying unit 40.

What is claimed is:

1. A cleaning method of cleaning residues from a semiconductor substrate by rotating a roll brush, the method comprising:
cleaning residues from the semiconductor substrate while pressing the roll brush against the semiconductor substrate with a first pressure of 7.35 kPa or lower; and
cleaning residues from the semiconductor substrate while pressing the roll brush against the semiconductor substrate with a second pressure higher than 7.35 kPa.

2. The method according to claim 1,
wherein the roll brush comprises a first and a second roll brushes; and
wherein the residues are cleaned from the semiconductor substrate while pressing the first and the second roll brushes against a front surface and a rear surface of the semiconductor substrate, respectively.

3. The method according to claim 1,
wherein a relative velocity on an outermost peripheral face of the roll brush with respect to the semiconductor substrate surface is 200 mm/s or higher.

4. The method according to claim 1,
wherein the first pressure and the second pressure are 2.1 kPa and 12.6 kPa, respectively.

5. The method according to claim 1, further comprising:
before the cleaning residues from the semiconductor substrate while pressing the roll brush against the semiconductor substrate with the first pressure of 7.35 kPa or lower, cleaning residues from the semiconductor substrate while pressing the roll brush against the semiconductor substrate with a third pressure of 12.6 kPa or higher.

6. The method according to claim 1, further comprising:
a cylinder configured to drive the roll brush in a vertical direction with respect to the semiconductor substrate surface,
wherein the pressures to press the roll brush against the semiconductor substrate is controlled by the cylinder.

7. A cleaning apparatus of cleaning residues from a semiconductor substrate by rotating a roll brush, the apparatus comprising:
a first rotate mechanism configured to rotate the roll brush;
a pressing mechanism configured to press the roll brush against at least one of a front surface and a rear surface of the semiconductor substrate while the roll brush is rotated; and
a controller configured to control a pressure of the pressing mechanism to press the roll brush against the semiconductor substrate,
wherein the controller controls the pressing mechanism to press the roll brush against with a first pressure of 7.35 kPa or lower, before to press the roll brush against the semiconductor substrate with a second pressure higher than 7.35 kPa.

8. The apparatus according to claim 7,
wherein the roll brush comprises a first and a second roll brushes; and
wherein the pressing mechanism presses the first and the second roll brush against the front surface and the rear surface of the semiconductor substrate, respectively.

9. The apparatus according to claim 7,
wherein the first rotate mechanism rotates the roll brush at a relative velocity of 200 mm/s or higher on an outermost peripheral face of the roll brush with respect to the semiconductor substrate surface.

10. The apparatus according to claim 7,
wherein the first and the second pressures are 2.1 kPa and 12.6 kPa, respectively.

11. The apparatus according to claim 7,
wherein the controller controls the pressing mechanism to press the roll brush against the semiconductor substrate with a third pressure of 12.6 kPa or higher, before to press the roll brush against the semiconductor substrate with the first pressure of 7.35 kPa or lower.

12. The apparatus according to claim 7, further comprising:
a second rotate mechanism configured to grip at edge portions of the semiconductor substrate and to rotate the semiconductor substrate.
